(19) United States
(12) Patent Application Publication
(10) Pub. No.: US 2026/0163755 A1
(43) Pub. Date: Jun. 11, 2026

(54) POWER MANAGEMENT SYSTEM, METHOD FOR TRANSMITTING DATA IN A POWER MANAGEMENT SYSTEM, AND INTEGRATED CIRCUIT

(71) Applicant: MEDIATEK INC., Hsinchu City (TW)

(72) Inventors: Hung-Sheng CHIEN, Hsinchu City (TW); Hui GUO, Hefei (CN)

(21) Appl. No.: 18/971,302

(22) Filed: Dec. 6, 2024

(51) Int. Cl. H04L 12/40; H04L 1/08; H04L 5/00

(52) U.S. Cl. CPC H04L 12/40039; H04L 1/08; H04L 5/0053; H04L 12/40019

(57) ABSTRACT

A power management system is provided. The power management system includes a SPMI master circuit, a SPMI slave circuit, and an interface bus connected between the SPMI master circuit and the SPMI slave circuit. The interface bus is a SPMI. The SPMI master circuit is configured to transmit a command to the SPMI slave circuit through the interface bus. The SPMI master circuit is further configured to perform a retransmission process. The retransmission process includes retransmitting the command to the SPMI slave circuit through the interface bus in response to not receiving an acknowledgement message from the SPMI slave circuit for longer than a pre-determined period of time after transmission of the command.

### BACKGROUND OF THE INVENTION

### Field of the Invention

The present invention relates to power management systems, and, in particular, to a power management system with a retransmission mechanism.

### Description of the Related Art

A system power management interface (SPMI) is an interface that enables a circuit that functions as the master circuit to communicate through a bus with a circuit that functions as the slave circuit. The SPMI allows systems to adjust the voltage by transmitting the command. However, the SPMI protocol doesn't have a mechanism to ensure that the command is received when there is interference during transmission.

Thus, the current SPMI protocol is not satisfactory in all aspects and can still be improved.

### BRIEF SUMMARY OF THE INVENTION

An embodiment of the present invention provides a power management system. The power management system comprises a SPMI master circuit, a SPMI slave circuit, and an interface bus connected between the SPMI master circuit and the SPMI slave circuit. The interface bus is a SPMI. The SPMI master circuit is configured to transmit a command to the SPMI slave circuit through the interface bus. The SPMI master circuit is further configured to perform a retransmission process. The retransmission process comprises retransmitting the command to the SPMI slave circuit through the interface bus, in response to not receiving an acknowledgement message from the SPMI slave circuit for longer than a pre-determined period of time after transmission of the command.

An embodiment of the present invention provides a method for transmitting data in a power management system. The method comprises transmitting a command to a SPMI slave circuit through the interface bus connected between a SPMI master circuit and the SPMI slave circuit using the SPMI master circuit. The interface bus is a SPMI. The method further comprises performing a retransmission process using the SPMI master circuit. The retransmission process comprises retransmitting the command to the SPMI slave circuit through the interface bus using the SPMI master circuit, in response to not receiving an acknowledgement message from the SPMI slave circuit for longer than a pre-determined period of time after transmission of the command.

In addition, an embodiment of the present invention provides an integrated circuit comprising a SPMI master circuit. The SPMI master circuit is configured to transmit a command to a SPMI slave circuit through an interface bus connected between the SPMI master circuit and the SPMI slave circuit. The interface bus is a SPMI. The SPMI master circuit is further configured to perform a retransmission process. The retransmission process comprises retransmitting the command to the SPMI slave circuit through the interface bus, in response to not receiving an acknowledgement message from the SPMI slave circuit for longer than a pre-determined period of time after transmission of the command.

### BRIEF DESCRIPTION OF THE DRAWINGS

The present invention can be more fully understood by reading the subsequent detailed description and examples with references made to the accompanying drawings, wherein:

FIG. 1 is a block diagram of the power management system in accordance with embodiments of the present disclosure;

FIG. 2 is a flow diagram of a method for transmitting data in the power management system in accordance with embodiments of the present disclosure; and

FIG. 3 is a flow diagram of a method for transmitting data in the power management system 100 in accordance with embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

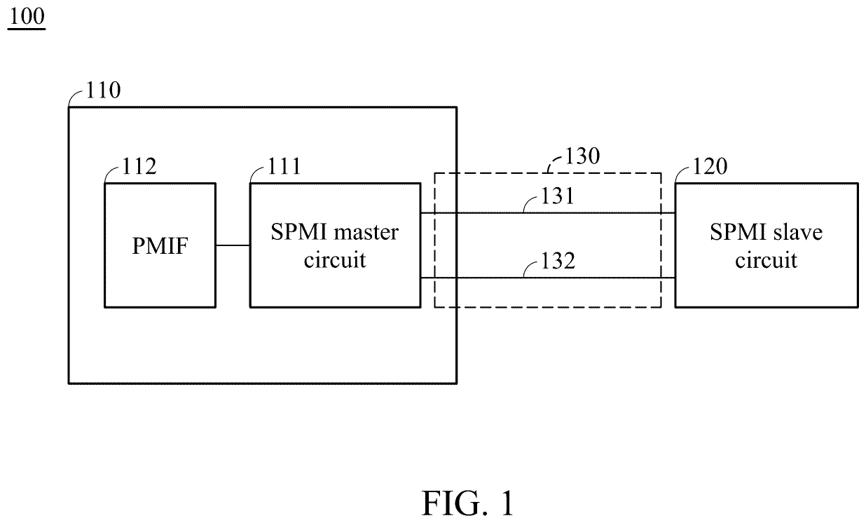

FIG. 1 is a block diagram of the power management system 100 in accordance with embodiments of the present disclosure. The power management system 100 comprises a main chip 110, a system power management interface (SPMI) slave circuit 120, and an interface bus 130. The power management system 100 may be reside in a mobile device, a wireless communication device, a cell phone, a tablet computer, a laptop computer, a desktop computer, a wearable device, or an Internet-of-thing device. The main chip 110 comprises a SPMI master circuit 110 and a power management interface (PMIF) 112 connected to the SPMI master circuit 110. The main chip 110 may be a system on a chip (SoC). The power management system 100, the SPMI master circuit 111, the PMIF 112, and the SPMI slave circuit 120 may be implemented in or comprised in the integrated circuit, chip, or chip set.

The PMIF 112 includes a plurality of channels, and each of the channel receives the command from a corresponding module and transmits the command to the SPMI master circuit 110. Thus, the PMIF 112 is configured to receive commands from at least one module and transmit the received commands to the SPMI master circuit 110. Furthermore, The PMIF 112 is configured to determine which command to execute according to the priorities of these commands. In some embodiments, the module may be a hardware module (e.g. circuit, chip, or device) or a software module (e.g. application or program). For example, the module may be a display, a Wi-Fi chip, a Bluetooth chip, a video application, an audio application, or any other module. These modules generate and transmit the command to the PMIF 112 so as to control the SPMI slave circuit 120. These modules may be referred to as the SPMI user. The command may be an indication to open/close a power supply or adjust the voltage of the SPMI slave circuit 120, and the SPMI slave circuit 120 is configured to execute the command.

The SPMI master circuit 111 is configured to translate the command into the machine language which is recognizable by the SPMI slave circuit 120. The translated command is transmitted from the SPMI master circuit 111 to the SPMI slave circuit 120 through the interface bus 130. The interface bus 130 is a bi-directional two-line buffer. The interface bus 130 comprises a first line 131 and a second line 132. The first line 131 is for data transmission, and the second line 132 is for clock signal transmission. In some embodiments, the interface bus 130 is a SPMI. The SPMI master circuit 111 and the SPMI slave circuit 120 (and the PMIF 112, the main chip 110, and the SPMI user) apply SPMI protocol to communicate with each other through the interface bus 130.

There may be interference on the interface bus 130 due to the hardware defect, and the interference will result in the command not being correctly received at the SPMI slave circuit 120. The command may be lost or become an unrecognizable error command. The present disclosure proposes a retransmission mechanism to solve the aforementioned problem.

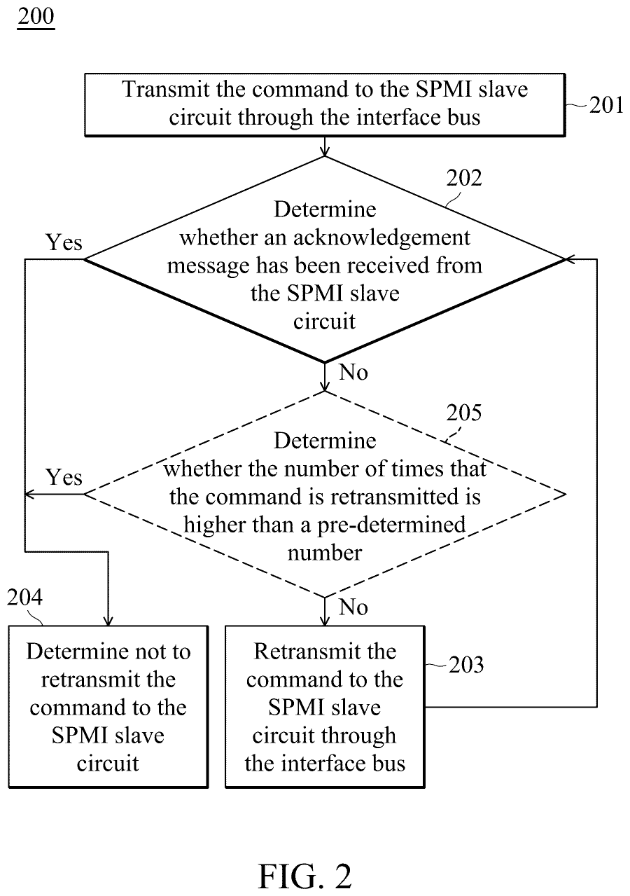

Refer to FIG. 2, which is a flow diagram of a method 200 for transmitting data in the power management system 100 in accordance with embodiments of the present disclosure. The method 200 can be implemented in the power management system 100. In operation 201, the SPMI master circuit 111 transmits the command to the SPMI slave circuit 120 through the interface bus 130. In operation 202, the SPMI master circuit 111 determines whether an acknowledgement message has been received from the SPMI slave circuit 120. The SPMI slave circuit 120 is configured to transmit the acknowledgement message to the SPMI master circuit 111, after receiving the command and confirming that the command is recognizable. On the other hand, when the SPMI slave circuit 120 doesn't receive the command or the command isn't recognizable, the SPMI slave circuit 120 doesn't transmit the acknowledgement message to the SPMI master circuit 111. Both the command and the acknowledgement message are transmitted on the first line 131 (the data transmission line). When the SPMI master circuit 111 receives the acknowledgement message from the SPMI slave circuit 120, the SPMI master circuit 111 performs operation 204. In operation 204, the SPMI master circuit 111 determines not to retransmit the command to the SPMI slave circuit 120.

Otherwise, when the SPMI master circuit 111 hasn't received the acknowledge message from the SPMI slave circuit 120 for longer than a pre-determined period of time after transmission of the command, the SPMI master circuit 111 performs operation 203 (or operation 205, in some embodiments). In operation 203, the SPMI master circuit 111 retransmits the command to the SPMI slave circuit 120 through the interface bus 130. Then, the SPMI master circuit 111 performs operation 202 again. The process (operations 202 and 203) may be repeated until the SPMI master circuit 111 receives the acknowledgement message form the SPMI slave circuit 120 and thus performs operation 204. In other words, the SPMI master circuit 111 automatically retransmits the command until the SPMI master circuit 111 receives the acknowledgement message from the SPMI slave circuit 120. Because the interference on the interface buffer 130 is temporary, the SPMI slave circuit 120 can receive the retransmitted command after the interference reduced or disappear.

In some embodiments, the SPMI master circuit 111 further performs an optional operation 205 after operation 202. Operation 205 might be skipped in some embodiments. In operation 205, the SPMI master circuit 111 determines whether the number of times that the command is retransmitted is higher than a pre-determined number. The SPMI master circuit 111 may record the number of times that the command (i.e. the command transmitted in the operation 201) is retransmitted in a register. In some embodiments, the number is set to zero in operation 201 and operation 204 and is added by 1 in operation 203. When the number of times that the command is retransmitted is higher than the pre-determined number, the SPMI master circuit 111 performs operation 204. When the number of times that the command is retransmitted is equal to or lower than the pre-determined number, the SPMI master circuit 111 performs operation 203. Thus, in this embodiment, the SPMI master circuit 111 retransmits the command until the SPMI master circuit 111 receives the acknowledgement message the from SPMI slave circuit 120 or the number of times that the command is retransmitted exceeds the pre-determined number. Performing operation 205 can prevent the system from being idle for a long time or crashed.

The operations 202˜205 may be referred to as a retransmission process. In some embodiments, the command comprises a control bit that instructs whether the SPMI master circuit 111 has to perform the retransmission process on the command. For a non-limiting example, when the control bit is “1”, the SPMI master circuit 111 performs the retransmission process on the command. When the control bit is “0”, the SPMI master circuit 111 doesn't perform the retransmission process on the command. In other words, the SPMI master circuit 111 determines whether to perform the retransmission process on the command based on the control bit. The control bit may be determined by the SPMI users. This allows different SPMI users to apply different polices on different commands based on the degree of importance of each command. As a result, not every command will be retransmitted, and the resource may be saved.

As described above, the SPMI users (i.e. modules that generate the commands) may include software modules and hardware modules. Some hardware modules do not have the ability to receive signals. These hardware modules are unable to receive the acknowledgement message. Thus, theses hardware modules are unable to determine whether the command is received and handle the retransmission issue. Furthermore, although some commands are transmitted through software modules, and theses software modules may be able to handle the acknowledgement message, it requires a lengthy process for these software modules to retransmit the command. Making every SPMI user be able to perform the retransmission process is costly and will waste a large layout area. Thus, it is beneficial to perform the retransmission process using only one hardware circuit, the SPMI master circuit 111.

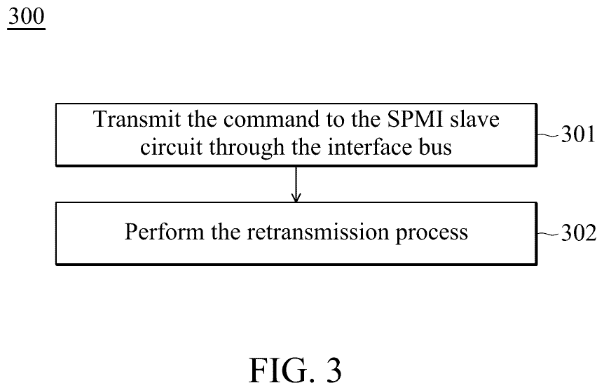

Refer to FIG. 3, which is a flow diagram of a method 300 for transmitting data in the power management system 100 in accordance with embodiments of the present disclosure. The method 300 can be implemented in the power management system 100. In operation 301, the SPMI master circuit 111 transmits the command to the SPMI slave circuit 120 through the interface bus 130. In operation 302, the SPMI master circuit 111 performs the retransmission process. The retransmission process comprises retransmitting the command to the SPMI slave circuit 120 through the interface bus 130 using the SPMI master circuit 111, in response to not receiving an acknowledge message from the SPMI slave circuit 120 for longer than the pre-determined period of time after transmission of the command.

In some embodiments, the command comprises a control bit that instructs whether the SPMI master circuit 111 has to perform the retransmission process on the command. In some embodiments, the retransmission process further comprises recording the number of times that the command is retransmitted in a register using the SPMI master circuit 111. The retransmission process further comprises determining not to retransmit the command to the SPMI slave circuit 120 using the SPMI master circuit 111 in response to the number of times that the command is retransmitted is higher than the pre-determined number.

In some embodiments, the retransmission process further comprises determining not to retransmit the command to the SPMI slave circuit 120 using the SPMI master circuit 111, in response to receiving the acknowledgement message from the SPMI slave circuit 120. In some embodiments, the SPMI slave circuit 120 is a PMIC.

In some embodiments, the retransmission process further comprises receiving the command from the PMIF 112 connected to the SPMI master circuit 111 using the SPMI master circuit 111. The PMIF 112 includes a plurality of channels, and each of the channel receives the command from a corresponding module (i.e. the SPMI user) and transmits the command to the SPMI master circuit.

A power management system and a method for transmitting data in the power management system are provided. The power management system and the method are able to ensure that the commands are received by the SPMI slave circuit. Furthermore, the power management system and the method performs the retransmission using a SPMI master circuit. Thus, the power management system and the method can improve the reliability of the data transmission in the power management system at a relatively low cost.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power management system, comprising:
a system power management interface (SPMI) master circuit;
a SPMI slave circuit; and
an interface bus, connected between the SPMI master circuit and the SPMI slave circuit, wherein the interface bus is a SPMI;
wherein the SPMI master circuit is configured to:
transmit a command to the SPMI slave circuit through the interface bus; and
perform a retransmission process which comprises:
retransmitting the command to the SPMI slave circuit through the interface bus, in response to not receiving an acknowledgement message from the SPMI slave circuit for longer than a pre-determined period of time after transmission of the command.

2. The power management system as claimed in claim 1, wherein the command comprises a control bit that instructs whether the SPMI master circuit has to perform the retransmission process on the command.

3. The power management system as claimed in claim 1, wherein the retransmission process further comprises:
recording a number of times that the command is retransmitted; and
determining not to retransmit the command to the SPMI slave circuit in response to the number of times that the command is retransmitted being higher than a pre-determined number.

4. The power management system as claimed in claim 1, wherein the retransmission process further comprises:
determining not to retransmit the command to the SPMI slave circuit in response to receiving the acknowledgement message from the SPMI slave circuit.

5. The power management system as claimed in claim 1, wherein the SPMI slave circuit is a power management integrated circuit (PMIC).

6. The power management system as claimed in claim 1, further comprising:
a power management interface (PMIF) connected to the SPMI master circuit;
wherein the PMIF includes a plurality of channels, each of the channel receives the command from a corresponding module and transmits the command to the SPMI master circuit.

7. A method for transmitting data in a power management system, comprising:
transmitting, via a system power management interface (SPMI) master circuit, a command to a SPMI slave circuit through an interface bus connected between the SPMI master circuit and the SPMI slave circuit, wherein the interface bus is a SPMI; and
performing, via the SPMI master circuit, a retransmission process which comprises:
retransmitting, via the SPMI master circuit, the command to the SPMI slave circuit through the interface bus, in response to not receiving an acknowledgement message from the SPMI slave circuit for longer than a pre-determined period of time after transmitting the command.

8. The method as claimed in claim 7, wherein the command comprises a control bit that instructs whether the SPMI master circuit has to perform the retransmission process on the command.

9. The method as claimed in claim 7, wherein the retransmission process further comprises:
recording a number of times that the command is retransmitted; and
determining not to retransmit the command to the SPMI slave circuit in response to the number of times that the command is retransmitted being higher than a pre-determined number.

10. The method as claimed in claim 7, wherein the retransmission process further comprises:
determining not to retransmit the command to the SPMI slave circuit in response to receiving the acknowledgement message from the SPMI slave circuit.

11. The method as claimed in claim 7, wherein the SPMI slave circuit is a power management integrated circuit (PMIC).

12. The method as claimed in claim 7, further comprising:
receiving the command from a power management interface (PMIF) connected to the SPMI master circuit;
wherein the PMIF is configured to receive the command from a module.

13. An integrated circuit, comprising:
a system power management interface (SPMI) master circuit, configured to:
transmit a command to a SPMI slave circuit through an interface bus connected between the SPMI master circuit and the SPMI slave circuit, wherein the interface bus is a SPMI; and
perform a retransmission process which comprises:
retransmitting the command to the SPMI slave circuit through the interface bus, in response to not receiving an acknowledgement message from the SPMI slave circuit for longer than a pre-determined period of time after transmitting the command.

14. The integrated circuit as claimed in claim 13, wherein the command comprises a control bit that instructs whether the SPMI master circuit has to perform the retransmission process on the command.

15. The integrated circuit as claimed in claim 13, wherein the retransmission process further comprises:
recording a number of times that the command is retransmitted; and
determining not to retransmit the command to the SPMI slave circuit in response to the number of times that the command is retransmitted being higher than a pre-determined number.

16. The integrated circuit as claimed in claim 13, wherein the retransmission process further comprises:
determining not to retransmit the command to the SPMI slave circuit in response to receiving the acknowledgement message from the SPMI slave circuit.
